(19) United States
(12) Patent Application Publication
(10) Pub. No.: US 2004/0021948 A1
(43) Pub. Date: Feb. 5, 2004

(54) Method and device for producing an optically antireflective surface

(76) Inventors: Benedikt Bläsi, (US); Volker Kübler, Merzhausen (DE); Andreas Gombert, Freiburg (DE); Volkmar Boerner, Freiburg (DE)

Correspondence Address: BURNS DOANE SWECKER & MATHIS L L P, POST OFFICE BOX 1404, ALEXANDRIA, VA, 22313-1404, US

(21) Appl. No.: 10/344,132

(22) PCT Filed: Aug. 9, 2001
(86) PCT No.: PCT/EP01/09233

(30) Foreign Application Priority Data
Aug. 9, 2000 (DE) 100 38 749.7

(51) Int. Cl. G02B 5/08; G02B 17/00

(52) U.S. Cl. 359/603

(57) ABSTRACT

Disclosed is a method for producing a surface structure which is antireflective for a wavelength range with a minimal wavelength λ_{M}, having a supporting coat on which a light-sensitive material is applied which is exposed with at least two mutually coherent wave fields with a wavelength of λ_{B} in order to obtain a stochastically distributed interference field, whereby during or after exposure, said surface structure is formed by means of selective removal of materials. The invention is distinguished by mutually interfering, coherent wave fields directed at the light-sensitive coat of material forming an angle α, for which applies:

α>2 arcsin(λ_{B}/(2·λ_{M}))

### BACKGROUND OF THE INVENTION

1. Field of the Invention

The present invention relates to a method and a device for producing an optically antireflective surface structure (e.g. for visible light) having a supporting coat on which a coat of light-sensitive material is applied, which is exposed to at least two mutually coherent wave fields with a wavelength of λ_{B} in order to obtain a stochastically distributed interference field, whereby during or after exposure, the surface structure is formed by means of selective removal of material.

2. Description of the Prior Art

At the interfaces of transparent media, such as for example glass or plastic panes, which are preferably used for windows, display screens or display surfaces of instruments, always one part of the incident light falling on the interface surfaces is reflected thus reflected back into the space from where the light comes. The reflex phenomena occurring on the interfaces of transparent media impair the transparency properties as well as the readability of display screens or displays considerably. There are prior art dereflection measures, which influence the reflection properties at the interfaces in various ways, for improving the transparency properties respectively the readability of display screens in general.

Thus, reflecting surfaces can, among other things, be dereflective by providing the surface with a suited roughness.

Although a not exactly small part of the incident light is reflected back into the room by roughening the interface surface, rays of light falling on the surface in parallel are reflected back in various directions due to the roughness of the surface. In this manner clear reflected images are prevented, that is light sources which normally would be reflected at the interfaces imaged with sharp outlines only lead to rather homogeneous brightening of the roughened interface. In this manner, stark differences in luminance can be prevented and the disturbing effect occurring with reflexes can be reduced considerably.

This type of dereflection, referred to as anti-glare coat, is successfully implemented, for example on displays. An substantial advantage of this dereflection method is the ability to mold the structure by means of inexpensive imprinting processes. However, a disadvantage of this type of dereflection is that the hemispherical reflection, i.e. the sum of mirroring and diffuse reflection into the entire rear part of the room, is in the most favorable case not increased. As a result the background brightness of glass surfaces of display screens treated in this manner is relatively high, which leads to a quite considerable reduction of the contrast of an image respectively of a display behind such an anti-glare coat.

Another possible manner of dereflecting optical surfaces is applying suited interference coats. The to-be-deflected surface is coated with one or several thin coats which have a suited refractive index and a suited thickness. The structure of the interference coat is designed in such a manner that, in suited wavelength ranges, destructive interference phenomena occur in the reflected radiation field, thereby greatly reducing the brightness of, for example reflexes of light sources. However, contrary to the aforementioned anti-glare coat, their imaging in the reflected radiation path remains sharp. Even if the visual residual reflection is less than 0.4%, the sharp mirror images are sometimes more disturbing than the relative great brightness of the anti-glare surfaces. The contrast relationship is good. For most display screens and other applications, however, interference coats are too expensive in production.

A third alternative for dereflecting optical surfaces is providing so-called subwavelength gratings, which result in a refractive index gradient on the interface of an optically transparent medium, whereby an optical effect similar to that of interference coats is created. One such refractive index gradient is realized by surface structures if the structures are smaller than the wavelengths of the incident light. Favorably suited for this is producing periodic structures by means of holographic exposure in a photoresist coat which is applied to the surface of a transparent medium. Examples of such types of subwavelength gratings are described in the printed publications DE 38 31 503 C2 and DE 2 422 298 A1.

Such types of subwavelength surface gratings with periods of 200 to 300 nm are suited for broadband reflection reduction. Surfaces known under the term “moth-eye-antireflection surfaces” are described in detail in the article “The Optical Properties of Moth-Eye-AntiReflection Surfaces” by M. C. Hutley, S. J. Wilson, in OPTICA ACTA, 1982, vol. 29, No. 7, pages 993-1009. Although the great advantage of such types of “moth-eye coats” is an inexpensive replicating mode of production by means of imprinting processes like those of anti-glare structures. However, large-surface production of such types of structures is very difficult due to only very narrow optical tolerance ranges with regard to the variance of structure depths and a very high aspect ratio, i.e. very high ratio of structure depth to structure period, which can lead to falsifying color effects. Moreover, in such types of surface coatings, images of light sources are imaged in the reflected image just as sharply as with interference coats.

Smallest surface structures can also be produced in the submicrometer range respectively in the subwave range by means of stochastic processes, for example using etching processes, such as for example are disclosed in the German Patent DE 2807414 C2. Furthermore, the article “Subwavelength-Structured Antireflective Surfaces on Glass” by A. Gombert et. al. in Thin Solid Films, 351 (1999), pp. 73 to 78, describes how stochastic surface structures which possess the aforedescribed antireflective properties can be obtained with the aid of selective layer growth. Although both methods permit replication of the obtained stochastic surface structures by means of prior art imprinting processes, the surface structures obtained using these methods have the drawback that the angle at which residual light is reflected back cannot be selectively set (e.g. small-angle scattering or scattering into a large solid angle).

It is also state of the art to obtain stochastic structures using other optical properties by means of holographic processes, for example in the production of optical diffusers. Optical processes capable of generating stochastically distributed interference patterns by means of holographic exposure have the advantage over the aforementioned stochastic process that the angle ranges at which the light is reflected back at surfaces structured in this manner can be set. A method in which a holographic interference pattern for imprinting a stochastically structured pattern is employed is described in the US printed publication U.S. Pat. No. 5,365,354. Diffusers can be produced with this method. A method for producing stochastic structures for diffusers is described in it but not a redeflecting method.

DE 19708776 C1 describes a method with which a combination surface structure possessing the properties of an antireflective coat as well as of an anti-glare coat is obtained by superimposing a coarse-grained speckle pattern and the image of a subwavelength grating.

### SUMMARY OF THE INVENTION

The object of the present invention is to improve a method for producing a surface structure that is antireflective for visible light in such a manner that, on the one hand, part of the light that is reflected back at the surface structure is considerably reduced and, on the other hand, that the back-reflected part of the light is selectively reflected back at certain solid angle ranges. In this manner, the reflection images occurring at the surface structure, although greatly reduced in contrast but nonetheless present in prior art surface structures, should be completely prevented as the back-reflected parts of the light should be reflected back diffuse. Moreover, the invented method should permit replication of the obtained surface structure using prior art imprinting processes, i.e. possibly occurring back cutting within the forming surface structures should be prevented completely. Finally, another object is to provide a device with which such types of surface structures, which moreover should feature a stochastic distribution, can be produced.

A key element of the present invention is that a method for producing a surface structure which is antireflective for a certain wavelength range, which has the smallest wavelength limit λ_{M}, having a supporting coat on which a coat of a light-sensitive material is applied which is exposed to at least two mutually coherent wave fields with a wavelength of λ_{B} in order to obtain a stochastically distributed interference field, whereby during or after exposure, the surface structure is formed by means of selective removal, is improved in such a manner that the mutually interfering, coherent wave fields directed at the coat of light-sensitive material form an angle α, with

α>2 arcsin(λ_{B}/(2·λ_{M})).

The angle relationship is based on the requirement that in producing dereflective structures by means of stochastic surfaces structures, the maximal lateral dimensions of the individual structure elements of the stochastic surface structures should be smaller than the wavelength impinging on the dereflective surface structures. The invented method is especially intended for producing dereflective or antireflective surface structures, which for example should have a dereflective effect in the visible spectral range. In other words, that the individual structure elements are not larger in their lateral expansion than λ_{M}˜approximately 380 nm, which just corresponds to the short-wave limit of the visible spectral range.

Preferably, at least one of the mutually interfering, coherent wave fields has a stochastic amplitude and phase distribution. The more wave fields, whose amplitudes are preferably equally large, impinge upon the coat of light-sensitive material at the above angle relationship, the better the achievable exposure results.

Wavelengths in the UV range are preferably suited for producing such types of surface stochastic structures so that, for example, an exposure wavelength of 364 nm(Ar-ion laser) yields an angle range of α>57°, which is formed by at least two mutually coherent interfering wave fields to produce the stochastic interference pattern. A sensible upper limit of the angle range for α is 180°. If short-wave exposure waves, for example λ_{B} of 266 nm (four times the NdYAG wavelength) are employed, the angle already commences at 41°.

In such types of exposure conditions, stochastically distributed surface structures can be obtained that have high-frequency structural parts, which again influence the diffuse reflection properties of the obtained surface structures so positively that the residual light reflected at certain solid angle ranges at the surface structure is redistributed, which for example have a great angular difference to the perpendicular on the surface. This is advantageous, because dereflection greatly reduces reflection, but does not suppress it completely. For the residual reflection, it is therefore desirable that it, for example in visual applications, is not deflected back at the view range angle or reflected asymmetrically at certain solid angle ranges.

The stochastically distributed surface structures produced with the invented method possess, as already previously mentioned, high-frequency structural parts such as known analogously from communication technology using Fourier formulae to interpret temporally varying signals. Analogously, in optics, the signals varying spatially from it, such as for example surface relief structures, can be analyzed spectrally. In the case of periodical surface relief structures, as for example in a subwavelength grating, only discrete spatial frequencies occur. A stochastic surface relief structure such as is obtained with the invented method, is distinguished by a continuous spatial frequency spectrum. Thus, if the incident light is perpendicular, only structures with spatial frequencies greater than the inverse of the wavelength of the radiation falling on the surface relief structure result in an antireflective effect without scattering, as is similarly the case with periodical subwavelength gratings. A special characteristic of stochastically distributed surface structures produced with the invented method is the formation of such types of surface structures with spatial frequencies that are about the same order of magnitude or larger than the inverse of the wavelength of the incident radiation. The largest structural depths in the stochastic surface structure correspond at least to the order of magnitude of the smallest wavelength of the light impinging upon the surface structure.

The original formation of such a type of stochastic surface structure presupposes a radiation source, which emits light with a coherence required for the formation of a stochastic interference pattern. Especially suited light sources are UV light emitting lasers, for example Ar-ion lasers whose light rays are brought to interfere with or without an upstream filter. The exposure waves λ_{B} should equal or be smaller than those light wave lengths impinging on the antireflective surface in a later application.

For formation of the surface structures, a light-sensitive coat, for example a photoresist coat is exposed with the stochastic interference pattern, thereby creating, after or during exposure, relief structures in the light-sensitive coat by means of distributing the intensity.

Thus, intensity distribution is able to cross-link, for example, low-molecular polymers within the light-sensitive coat, resulting in selective deformations in the surface of the coat. Alternatively, surface structures form by means of the exposing a photoresist coat and a subsequent developing step respectively an etching process.

The surface structures produced in this manner can be replicated using prior art replication processes, for example using drum imprinting methods, die imprinting methods or injection molding processes. The advantage of these processes is that structured surfaces can be inexpensively produced. All these methods can be easily applied as in the invented stochastic surface structure there is no under cutting. Galvanically produced matrixes can be used as an imprinting die or tool for large surface replication of microstructures. In this manner, many imprinting dies can be obtained in an advantageous way from one single original surface structure by means of recopying. Alternatively, a structure can also be applied in a die by means of an etching process.

More than one light source whose light waves impinge upon the to-be-exposed coat of material in a suited manner can also be employed. If only one light source, for example an excimer laser, is utilized, the light beam is preferably divergently widened in order to illuminate the entire surface of a diffuser whose central region is designed in such a manner that it is opaque. The diffuser is designed in such a manner that light can only pass through its peripheral regions, whereby the rays of light in the radiation direction are superimposed on the diffuser downstream in the invented manner. The supporting coat with the corresponding light-sensitive material coat is situated at a suited location downstream of the diffuser. In addition or alternatively, radiation sources with a defined intensity profile may be employed, additional masks, filters with speckle patterns or the like, beam-forming optical means can be placed in the beam path in order to generate the desired interference pattern.

Several fight sources with different illumination wavelengths λ_{B} can also be used and utilized.

### BRIEF DESCRIPTION OF THE DRAWING

The present invention is made more apparent in the following, by way of example without the intention of limiting the scope or spirit of the overall inventive idea, using a preferred embodiment with reference to the accompanying drawing. Depicted is in:

FIG. 1 an radiation setup for producing a stochastic surface structure.

### DESCRIPTION OF PREFERRED EMBODIMENTS OF THE INVENTION

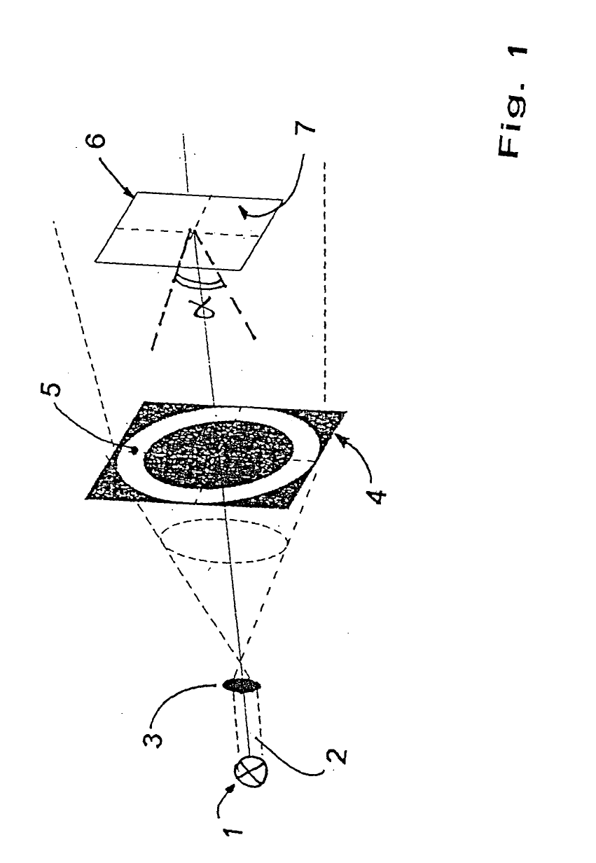

FIG. 1 shows an radiation setup having a light source 1, preferably an excimer laser, for example an Ar-ion laser, which emits a coherent light beam 2. A lens 3, which widens the light beam 2 to a diffuser unit 4 which provides an optically diffuse acting, transparent ring region 5 and is otherwise designed opaque, is provided in the beam path downstream of the light source. In the beam path downstream of the diffuser unit 4, a supporting plate 6 is provided on which a photoresist coat 7 is applied.

The single waves coming from the diffuser unit 4 interfere on the side facing away from the light source in such a manner that partial waves from opposite sectors of the diffuser unit, preferably designed as a ring diffuser, form a large angle α, determined by the geometric measurements of the ring region 5 and the distance between the diffuser unit 4 and the supporting plate 6. Due to the given geometry, mainly light waves impinge upon the photoresist coat 7, which form a great incident angle relative to the plane of the photoresist coat 7, thereby creating on the photoresist coat surface relief structures with high spatial frequencies with high amplitudes coat by means of corresponding illumination followed by subsequent development in the photoresist coat. In this way, the dereflective effect and a selective redistribution of the back reflexes is achieved.

Especially with regard to uncomplicated replicability of the surface structure on the supporting plate 6, the stochastic surface structure has high-frequency structural parts with amplitudes, which ideally lie in the same order of magnitude as the typical lateral dimensions of these structural parts.

### List of r fer nc Numerals

1 light sources

2 light beam

3 optical lens

4 diffuser unit

5 transparent ring region

6 supporting plate

7 photoresist coat

What is claimed is:

1. A method for producing a surface structure which is antireflective for a wavelength range with a minimal wavelength λ_{M}, having a supporting coat on which a light-sensitive material is applied which is exposed with at least two mutually coherent wave fields with a wavelength of λ_{B} in order to obtain a stochastically distributed interference field, whereby during or after exposure, said surface structure is formed by means of selective removal of materials,
wherein said mutually interfering, coherent wave fields directed at said light-sensitive coat of material form an angle α, for which applies:
α>2 arcsin(λ_{B}/(2·λ_{M}))

2. The method according to claim 1,
wherein one or several UV light emitting lasers are utilized as the light source.

3. The method according to claim 1 or 2,
wherein said stochastic interference field has a stochastic amplitude and phase distribution for whose generation one or several optical diffusers, masks, filters with speckle patterns and/or similar, beam-forming optical means are utilized.

4. The method according to one of the claims 1 to 3,
wherein a polymer coat is utilized as said coat of light-sensitive material in which cross-linking processes occur due to exposure, leading to local changes in the refractive index and/or deformations on said surface.

5. The method according to one of the claims 1 to 4,
wherein a photoresist coat is utilized as said coat of light-sensitive material, which, after exposure, is subjected to a developing process in which said surface structure is formed.

6. The method according to one of the claims 1 to 5,
wherein said surface structure on said coat of light-sensitive material is transferred onto an imprinting die by means of galvanic molding or an etching process for further replication of said surface structure onto other surfaces.

7. A device for producing a surface structure which is antireflective for a wavelength range with a minimal wavelength of λ_{M}, having a supporting coat on which a coat of light-sensitive material is applied, at least one light source, which emits light of a wavelength λ_{B} which is directed at said coat of light sensitive material in such a manner that at least two wave fields interfere with each other in such a manner that said coat of material is exposable by means of a stochastically distributed interference field,
wherein between said light source and said coat of light-sensitive material at least one optical diffuser is provided in such a manner that mutually interfering wave fields impinge upon said coat of light-sensitive material, said wave fields forming an angle α, for which applies:
α>2 arcsin(λ_{B}/(2·λ_{M}))

8. The device according to claim 7,
wherein said diffuser is a ring diffuser, the central region of which is designed opaque.

9. The device according to claim 8,
wherein said ring diffuser is designed in such a manner that the amplitudes of said wave fields coming from opposite sectors of said ring diffuser are equally large.

10. A device according to the generic part of claim 7,
wherein at least two light sources are provided whose light beams impinge obliquely on said coat of light-sensitive material and form an angle α, for which applies
α>2 arcsin(λ_{B}/(2·λ_{M}))
and in the beam path of said light beams at least one optical diffuser, filter with speckle patterns, a mask, and/or similar, beam-forming optical means are provided.

11. The device according to claim 10,
wherein the radiation sources emit a light beam with a defined intensity distribution.

12. The device according to claim 11,
wherein the radiation source is a UV light source in the manner of an excimer laser.

13. The device according to claim 10,
wherein said beam-forming optical means is an axicon.
